(19) United States
(12) Patent Application Publication
(10) Pub. No.: US 2007/0033640 A1
(43) Pub. Date: Feb. 8, 2007

(54) Generic context service in a distributed object environment

(75) Inventors: Eric Nels Herness, Byron, MN (US); Xiaochun Mei, Palo Alto, CA (US); Chendong Zou, Cupertino, CA (US)

Correspondence Address: DUKE W. YEE, P.O. BOX 802333, YEE & ASSOCIATES, P.C., DALLAS, TX, 75380, US

(73) Assignee: International Business Machines Corporation, Armonk, NY (US)

(21) Appl. No.: 11/187,291

(22) Filed: Jul. 22, 2005

(51) Int. Cl. H04L 9/32

(52) U.S. Cl. 726/5

(57) ABSTRACT

A context framework allows context propagation over synchronous invocation and asynchronous invocation. A context carrier is created for each thread. A set of application programming interfaces allow software components to store and retrieve context entries. By referring to the context carrier and creating a new context carrier when a new thread is started, context can flow both upstream and downstream along the invocation chain.

### BACKGROUND OF THE INVENTION

1. Field of the Invention

The present invention relates generally to data processing systems and, in particular, to context propagation in a distributed object environment.

2. Description of the Related Art

Distributed object component technology has evolved to provide a solid foundation for modern business application design in online transaction processing systems. These component technologies include, for example, the use of the Java™ programming language, the Java™ 2 enterprise edition (J2EE) programming model, and component technologies, such as Java™ server pages (JSPs), servlets, and portlets for online presentation logic. Component technologies also include, for example, service-oriented architecture (SOA), which is an architecture that allows loose coupling and reuse of software components.

These component models are expressly designed to enable a strong separation of concerns between business application logic and the underlying information systems technology on which those application components are hosted. This separation enables application developers to focus on domain knowledge, adding value to their business, and to avoid the intricacies of distributed information systems technology. Further, these component models enable declarative approaches to enforcing security, the relationships between objects, internationalization, serviceability, and persistence, essentially virtualizing the relationship of the business application component to its underlying information system.

Software components, also referred to as services or processes, may need context information to handle messages at runtime. Context information augments the message contents by providing extra information about the contents and might include information on how to handle and process the message itself. For example, in order to monitor a business process, one may wish to pass along a set of business context data (e.g., trace level, monitor target) that is not part of the business interface of the target component.

Traditional context propagation mechanisms do not address the needs of a SOA environment. Traditional context propagation mechanisms assume a tightly integrated and synchronous environment. These assumptions may not be true in a SOA environment, where software components are loosely coupled and may interact with each other asynchronously. If one wants to propagate context asynchronously around loosely coupled systems, one must do this deliberately with specific code written within the software components themselves. Such specialized code defeats the purpose of using a SOA environment.

### SUMMARY OF THE INVENTION

The present invention recognizes the disadvantages of the prior art and provides a context framework that allows context propagation over synchronous invocation and asynchronous invocation. A context carrier is created automatically for each thread. A set of application programming interfaces allow software components to store and retrieve context entries. By referring to the context carrier and creating a new context carrier when a new thread is started, context can flow both upstream and downstream along the invocation chain.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which aspects of the present invention may be implemented;

FIG. 2 is a block diagram of a data processing system that may be implemented as a server is depicted in accordance with exemplary aspects of the present invention;

FIG. 3 illustrates an example of distributed software component environment in which exemplary aspects of the present invention may be implemented;

FIG. 4 is a block diagram illustrating the software configuration of a data processing system implementing an open software component environment in accordance with exemplary aspects of the present invention;

FIGS. 5A-5C are block diagrams depicting context propagation with synchronous invocation in accordance with an illustrative embodiment of the present invention;

FIGS. 6A-6D are block diagrams depicting context propagation with asynchronous invocation in accordance with an illustrative embodiment of the present invention;

FIG. 7 is a block diagrams depicting context propagation with asynchronous invocation across a transport in accordance with an illustrative embodiment of the present invention; and

FIG. 8 is a flowchart illustrating the operation of a context manager in a distributed software component environment in accordance with an exemplary embodiment of the present invention.

### DETAILED DESCRIPTION OF THE PREFERRED EMBODIMENT

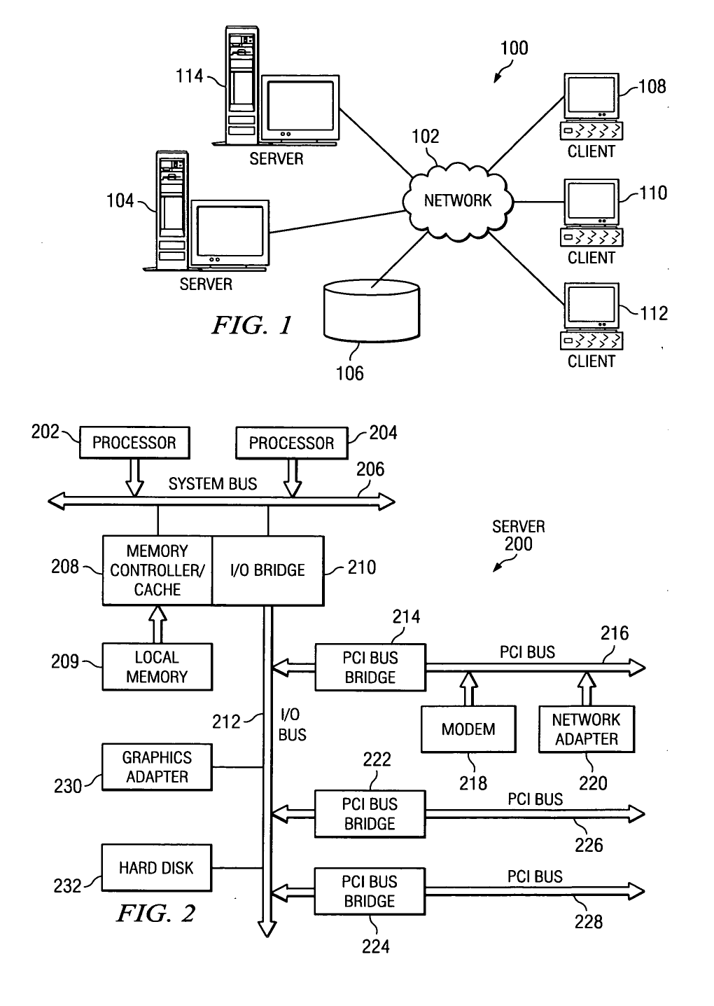

FIGS. 1-3 are provided as exemplary diagrams of data processing environments in which embodiments of the present invention may be implemented. It should be appreciated that FIGS. 1-3 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

Referring to FIG. 2, a block diagram of a data processing system that may be implemented as a server, such as server 114 in FIG. 1, is depicted in accordance with exemplary aspects of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer™ pSeries® system, a product of International Business Machines Corporation in Armonk, N.Y., running the Advanced Interactive Executive (AIX™) operating system or Linux™ operating system.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a general purpose data processing system, such as a desktop computer system.

A bus system may be comprised of one or more buses, such as bus 206, bus 212, or bus 216 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 218 or network adapter 220 of FIG. 2. A memory may be, for example, local memory 209 shown in FIG. 2, a read only memory (not shown), or a cache (not shown). The depicted examples in FIGS. 1-2 and above-described examples are not meant to imply architectural limitations.

Returning to FIG. 1, Network data processing system 100 may provide a distributed object environment. For example, server 104 may provide terminal services and other clients, server 114 may provide web services clients, and storage 106 may store core business functions and persistent business objects. Distributed objects are software modules that are designed to work together, but may reside in multiple computer systems throughout the network. A program in one machine sends a message to an object in a remote machine to perform some processing and the results are sent back to the calling machine. Distributed objects over the Web are known as “Web services.” “Terminal services” enable an application to be run simultaneously by multiple users at different clients. Terminal services turn a server into a centralized, timeshared computer. All the data processing (business logic) is performed in the server, and the clients display only the user interface and screen changes.

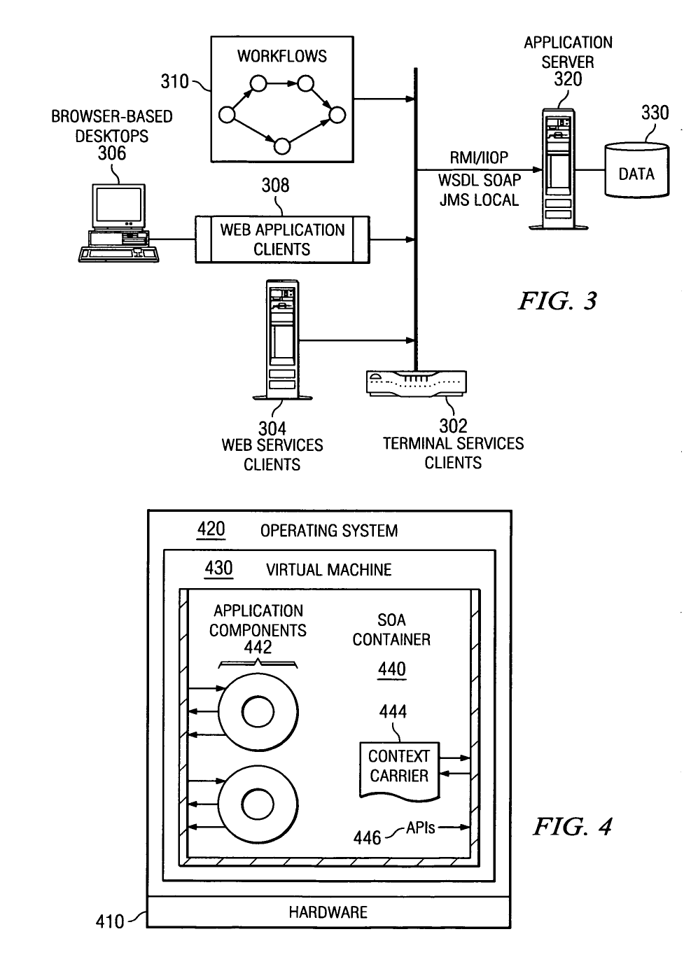

FIG. 3 illustrates an example of distributed software component environment in which exemplary aspects of the present invention may be implemented. The distributed software component environment may be implemented in J2EE as a service-oriented architecture (SOA) container. Application server 320 includes software components, which may be implemented in J2EE as a service-oriented architecture (SOA) container, for example. The software components may then be invoked by a variety of clients, including terminal services clients 302, Web services clients 304, browser-based desktops 306 and Web application clients 308, and workflows 310, to name a few.

A “workflow” is a script, or a series of steps to be executed to perform a procedure. A workflow engine (not shown) invokes the tasks or activities that have been scripted into the workflow. These steps typically involve performing transactions using software components executing on application server 320.

Data 330 represents persistence of the data being processed by software components running on application server 320. Persistent data, such as database tables and the like, are stored in data 330.

Clients 302-310 may access software components through, for example, Remote Method Invocation over Internet Inter-ORB Protocol (RMI/IIOP), Web Services Description Language (WSDL), Simple Object Access Protocol (SOAP), JAVA Messaging Service (JMS), or local access. RMI/IIOP allows Java™ access to non-Java™ processes via Common Object Request Broker Architecture (CORBA). WSDL is a protocol for a Web service to describe its capabilities. SOAP is a message-based protocol based on extensible Markup Language (XML) for accessing services on the Web. JMS is an application programming interface (API) from Sun Microsystems for connecting Java™ programs to messaging middleware. JMS is part of the J2EE platform.

FIG. 4 is a block diagram illustrating the software configuration of a data processing system, such as application server 320 in FIG. 3, implementing an open software component environment in accordance with exemplary aspects of the present invention. Operating system 420 runs on Hardware 410. Operating system A20 provides hardware and system support to software executing on the specific hardware platform of hardware 410.

Virtual machine 430 is one software application that may execute in conjunction with operating system 420. Virtual machine 430 provides a runtime environment with the ability to execute an application. Virtual machine 430 may be, for example, a Java™ virtual machine, which executes software components written in the Java™ programming language. A computer system in which virtual machine 430 operates may be similar to data processing system 200 in FIG. 2 described above. However, virtual machine 430 may be implemented in dedicated hardware on a so-called JavaChip™ device or a Java™ processor with an embedded picoJava™ core.

The virtual machine is a virtual computer, i.e. a computer that is specified abstractly. The Java™ specification defines certain features that every Java™ virtual machine must implement, with some range of design choices that may depend upon the platform on which the Java™ virtual machine is designed to execute. For example, all Java™ virtual machines must execute Java™ bytecodes and may use a range of techniques to execute the instructions represented by the bytecodes. Virtual machine 430 may be implemented completely in software or somewhat in hardware. This flexibility allows different virtual machines to be designed for different hardware platforms.

Service-oriented architecture (SOA) container 440 is one software application that may execute in conjunction with virtual machine 430. Container technology is designed to help simplify component development and let component developers to concentrate on their business logic and not worry about actual implementation. Developers can express their intent via metadata specifications, such as deployment descriptors. An example would be a J2EE container, which supports transaction policies of Enterprise Java™ Beans (EJBs) Thus, SOA container 440 provides policies, a contract of sorts, with which software components must comply in order to execute.

In addition, containers have been extended to optimize the management of those components to reach optimal throughput in a fully loaded system. This results in application designs that are more flexible, durable, and portable. Componentization enables a higher degree of re-use and sharing of application logic and data, thus improving developer productivity and business process integration. In addition, containers manage components to enforce the contractual obligations of that component model for the business logic they contain.

Service component architecture (SCA) offers some extensibility points where one can plug in extensions for a particular purpose. Two particular extension points are the qualifier extension point and the container extension point. A container extension point allows one to plug in a container extension that would get invoked whenever a container breach happens. A container breach happens when one component has to invoke another component. A qualifier extension allows one to add an extension or plug-in that would get invoked whenever the invocation flows through the container. For example, an interface qualifier extension would get invoked when a component that supports that interface gets invoked. Qualifier extensions have to be declared on the component's interface or reference.

Software components 442 execute in SOA container 440. In accordance with exemplary aspects of the present invention, SOA container 440 also provides a context manager, which can be used by components. The context manager provides a set of application programming interfaces (APIs) 446 that enable a developer to easily utilize the infrastructure. An example of the set of APIs 446 is as follows:

public Serializable get(String key)—get the corresponding context data for the given key;

public void set(String key, Serializable value)—set the corresponding context data to be ‘value’ for the given key;

public void remove(String key)—remove the corresponding context data for the given key;

public void setSessionContext(ActivityData theContext)—set the current context; and,

public ActivityData getSessionContext( )—get the current context.

SOA container 440, including its policies and APIs 446, make up the SOA runtime environment.

In accordance with exemplary aspects of the present invention, SOA container 440 provides functionality for a context manager as an extension or plug-in of SOA container 440. When a thread is started, an extension or plug-in of SOA container 440 creates context carrier 444. Software components 442 may store context information to and retrieve context information from context carrier 444 via APIs 446.

Each context carrier may be assigned an identification (ID). Each context entry may be identified by a key. In synchronous invocation, a first software component may propagate its context information by referring to the ID of the context carrier and the key of the context entry in the header of the invocation message. In asynchronous invocation, a first software component may embed the context information in the header of the invocation message. Then, the invoked software component may create a context entry in the context carrier associated with its thread. When a thread is terminated, its associated context carrier is deleted.

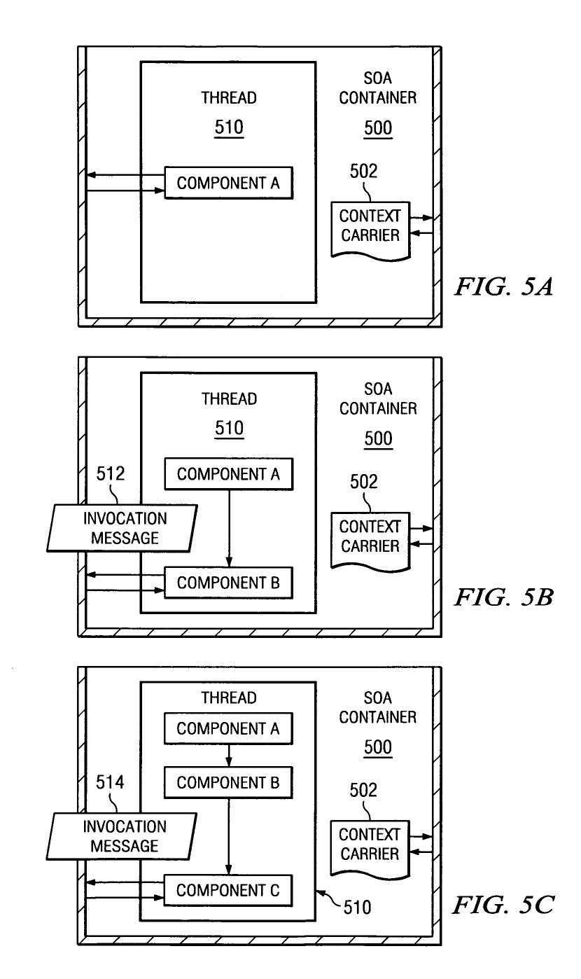

FIGS. 5A-5C are block diagrams depicting context propagation with synchronous invocation in accordance with an illustrative embodiment of the present invention. With reference to FIG. 5A, component A runs in thread 510. Context carrier 502 is associated with thread 510. Component A may create context entries in context carrier 502 via the APIs, which are part of the context manager of SOA container 500.

Turning to FIG. 5B, component A invokes component B by generating invocation message 512. Component A invokes component B synchronously, meaning component A will wait for the result of component B before performing any more processing. Component B may then access the context information in context carrier 502. Component A may simply refer to context carrier 502 by ID and pass a particular context entry by key. With reference now to FIG. 5C, component B invokes component C synchronously by generating invocation message 514. Again, the context information follows because it is associated with the thread. Component C may then access the context information in context carrier 502.

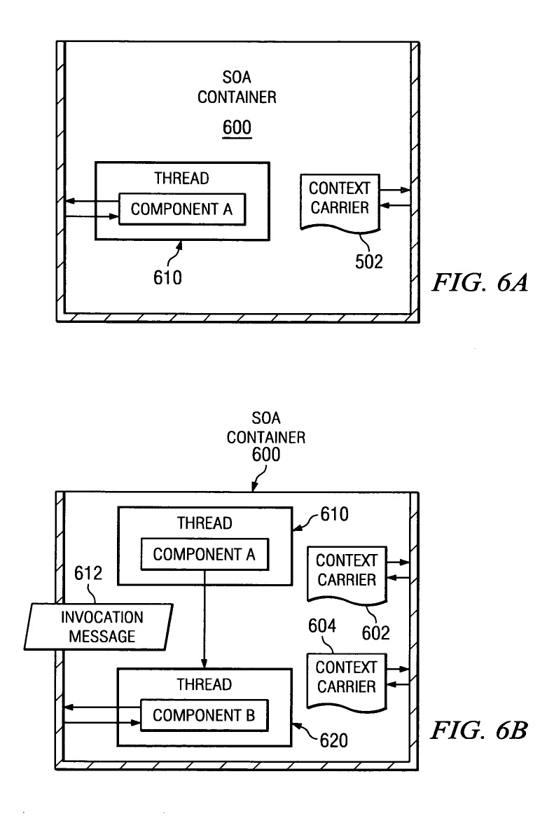

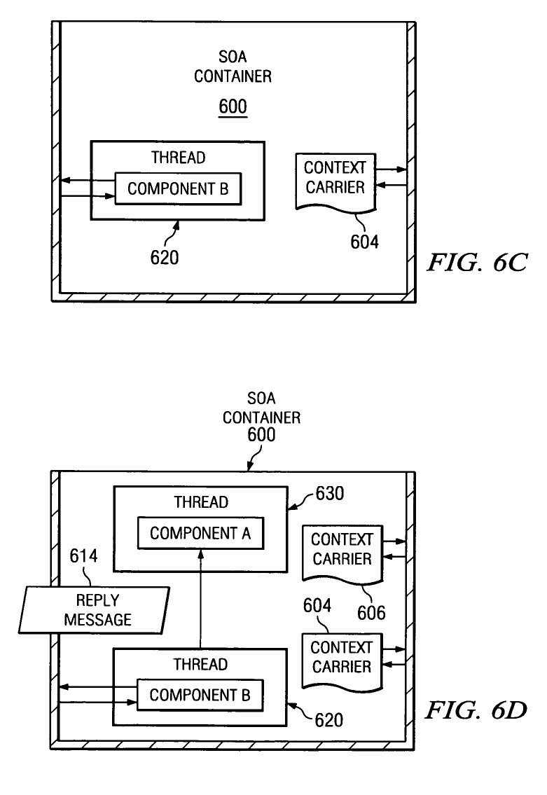

FIGS. 6A-6D are block diagrams depicting context propagation with asynchronous invocation in accordance with an illustrative embodiment of the present invention. With reference to FIG. 6A, SOA container 600 starts thread 610 and runs component A. Context carrier 602 is associated with thread 610. Component A may create context entries in context carrier 602 via the APIs of SOA container 600.

Turning to FIG. 6B, component A invokes component B by generating invocation message 612. Because component A invokes component B asynchronously, component A may not wait for the results from component B. Thus, component A may perform some other function, invoke another component, or terminate. In this example, component A embeds its current context information in the header of invocation message 612, sends the message, and terminates. SOA container 600 then starts thread 620 and runs component B. Context carrier 604 is associated with thread 620. Component B may then create context entries in context carrier 604 via the APIs of SOA container 600.

As seen in FIG. 6C, when component A terminates, thread 610 also terminates and context carrier, which was associated with thread 610, is deleted.

Next, with reference to FIG. 6D, component B returns results to component A through reply message 614. SOA container then starts thread 630 and restarts component A. Component B embeds its context information in the header of reply message 614 and component A creates context entries in context carrier 606. Thus, the context manager of SOA container 600 propagates context both upstream and downstream along the invocation chain.

In the example shown in FIG. 6B, the results are returned to component A in a reply message. This is known as a “push” or “callback.” Alternatively, component A may lie dormant for a sufficient amount of time and then “pull” the response from component B.

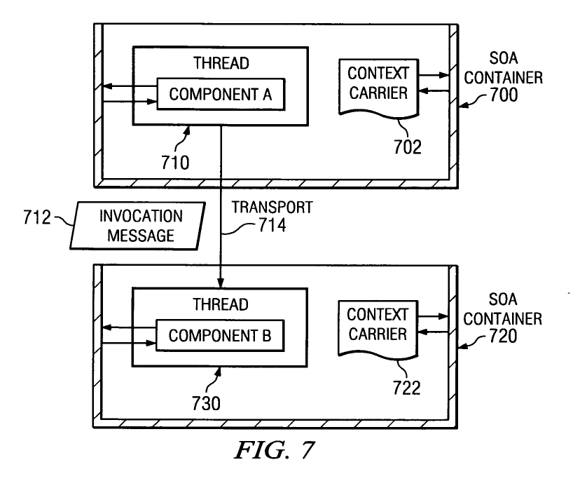

FIG. 7 is a block diagrams depicting context propagation with asynchronous invocation across a transport in accordance with an illustrative embodiment of the present invention. SOA container 700 starts thread 710 and runs component A. Context carrier 702 is associated with thread 710. Component A may create context entries in context carrier 702 via the APIs of SOA container 700. Component A invokes component B by generating invocation message 712.

SOA container 720 receives invocation message 712 via transport 714. Transport 714 may be, for example, a CORBA call via RMI/IIOP. SOA container 700 and SOA container 720 may exist within the same virtual machine, on the same physical machine, or on different physical machines. SOA container 720 then starts thread 730 and runs component B. Context carrier 722 is associated with thread 730. Component B may then create context entries in context carrier 722 via the APIs of SOA container 720.

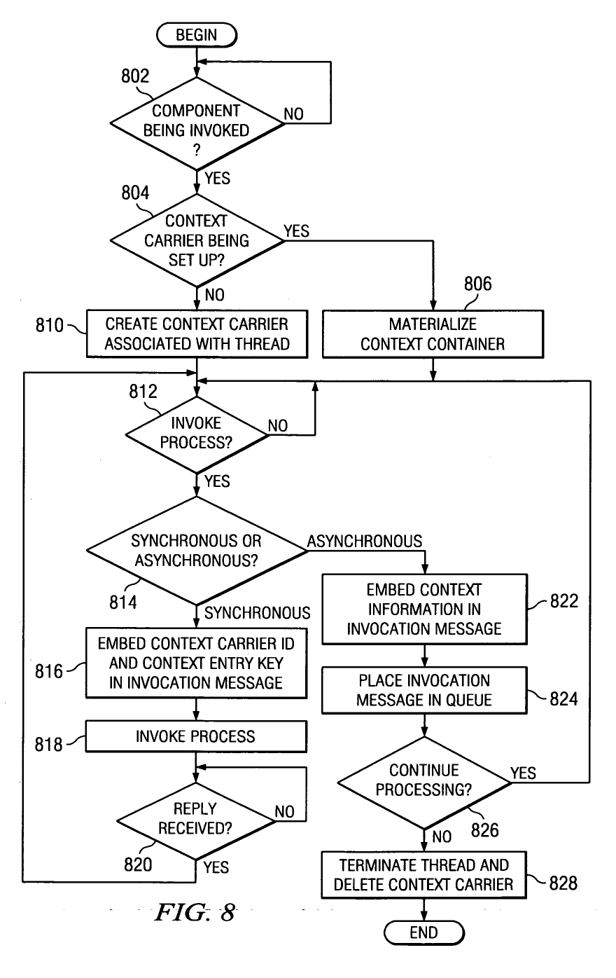

FIG. 8 is a flowchart illustrating the operation of a context manager in a distributed software component environment in accordance with an exemplary embodiment of the present invention. Operation begins and the context manager determines whether a component is being invoked (block 802). If a component is not being invoked, operation returns to block 802 and loops until a component is invoked.

If a component is being invoked in block 802, the context manager determines whether a context carrier is being set up (block 804). This is done by looking up if there is a context carrier associated with the thread in the synchronous case, or looking at the invocation message in the asynchronous case. If a context carrier is not yet set up, the context manager creates a context carrier associated with the thread (block 810). Thereafter, the context carrier determines whether the component invokes a process (block 812).

A context carrier is uniquely identified by its ID. In addition, a unique session ID is created to identify the session. In various incarnations of a context carrier, it will have the same logical ID—the session ID. If a context carrier is set up in block 804, then the context manager materializes the context carrier out of the invocation message header, creates the context carrier for it, and generates the context information within the context carrier (block 806). A “creation” of a context carrier is done when there is no session (the logical carrier) established, which happens when an event or invocation first comes into the SOA system. After a session is established, then a carrier may materialize itself multiple times on various threads of execution that are part of the initial invocation/events. Then, operation proceeds to block 812 to determine whether the component invokes a component.

If the component does not invoke a component in block 812, operation returns to block 812. If the component invokes a software component in block 812, the context manager determines whether the invocation is synchronous or asynchronous (block 814). If the invocation is synchronous, the context manager embeds the context carrier ID and current context key in the header of the invocation message (block 816). However, in the synchronous case, the thread is the same. Thus, in an alternative embodiment, this can be optimized without actually putting the context carrier ID and context entry key in the header, because the invoked component can simply look up the context carrier data associated with its thread. Next, the runtime environment invokes the component (block 818).

The software component determines whether a reply is received (block 820). If a reply is not received from the invoked component, the software component returns to block 820 and waits until a reply is received. If a reply is received in block 820, operation returns to block 812 to determine whether the software component invokes another component.

Returning to block 814, if the invocation is asynchronous, the context manager embeds the context information in the header of the invocation message (block 822). Next, the runtime environment places the message in a queue (block 824) and determines whether the software component is to continue processing (block 826). Because the invocation is asynchronous, the software component may perform other processing functions, such as invoking other components, or terminate. If the software component is to continue processing, operation returns to block 812 to determine whether the software component invokes another component. Otherwise, if the software component is not to continue processing in block 826, the runtime environment terminates the thread and deletes the context carrier associated with the thread (block 828). Thereafter, operation ends.

Once an asynchronous invocation is made, the invoking component may run at a later time to “pull” the results. Alternatively, a reply message may be sent from the invoked component to the invoking component as a “push.” Receiving a reply message from the invoked component, either as a push or a pull, may be seen as a component being invoked in block 802.

Thus, in the illustrative embodiments, the present invention solves the disadvantages of the prior art by providing a distributed software component architecture in which a context manager at runtime handles context propagation. The context framework allows context propagation over synchronous invocation and asynchronous invocation. A context carrier is created for each thread and all incarnations of a context carrier belong to the same logical session. A set of application programming interfaces allow software components to store and retrieve context entries. By referring to the context carrier and creating a new context carrier when a new thread is started, context can flow both upstream and downstream along the invocation chain.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for context propagation, the computer implemented method comprising:
responsive to invoking a first software component, creating a first context carrier associated with a first session;
creating a first context entry in the first context carrier, wherein the first context entry stores context information associated with the first software component; and
responsive to the first software component invoking a second software component, propagating the context information associated with the first software component to the second software component using the first context carrier.

2. The computer implemented method of claim 1, wherein the first context carrier has a unique identifier associated with the first session and wherein the first context entry is identified by a key.

3. The computer implemented method of claim 2, wherein the first software component invokes the second software component synchronously and wherein the second software component accesses the first context entry using the unique identifier and the key.

4. The computer implemented method of claim 1, wherein the first software component invokes the second software component asynchronously by generating an invocation message.

5. The computer implemented method of claim 4, wherein propagating the context information associated with the first software component comprises embedding the context information associated with the first software component in the invocation message.

6. The computer implemented method of claim 5, further comprising:
running the second software component in a second session;
creating a second context carrier associated with the second session; and
creating a second context entry in the second context carrier, wherein the second context entry stores the context information associated with the first software component.

7. The computer implemented method of claim 6, further comprising:
terminating the first software component; and
deleting the first context carrier.

8. The computer implemented method of claim 6, further comprising:
returning a reply message from the second software component to the first software component, wherein the reply message has embedded therein the context information associated with the first software component;
invoking the first software component;
creating a third context carrier associated with the first session; and
creating a third context entry in the third context carrier, wherein the third context entry stores the context information associated with the first software component.

9. A data processing system comprising:
a hardware platform;
a distributed component runtime environment running on the hardware platform, wherein the distributed component runtime environment includes a context manager comprising:
a context carrier creation function that creates a context carrier associated with a given session;
a context entry set function that stores a context entry associated with a given software component in a context entry in the context carrier;
a context entry get function that gets context data from a given context entry.

10. The data processing system of claim 9, wherein the context manager comprises a set of application programming interfaces.

11. The data processing system of claim 9, wherein the distributed component runtime environment is a service-oriented architecture container.

12. The data processing system of claim 11, wherein the service-oriented architecture container runs in a virtual machine on the hardware platform.

13. A computer program product, comprising:
a computer usable medium having computer usable program code for context propagation, the computer usable program code comprising:
computer usable program code, responsive to invoking a first software component, for creating a first context carrier associated with a first session;
computer usable program code for creating a first context entry in the first context carrier, wherein the first context entry stores context information associated with the first software component; and
computer usable program code, responsive to the first software component invoking a second software component, for propagating the context information associated with the first software component to the second software component using the first context carrier.

14. The computer program product of claim 13, wherein the first context carrier has a unique identifier associated with the first session and wherein the first context entry is identified by a key.

15. The computer program product of claim 14, wherein the first software component invokes the second software component synchronously and wherein the second software component accesses the first context entry using the unique identifier and the key.

16. The computer program product of claim 13, wherein the first software component invokes the second software component asynchronously by generating an invocation message.

17. The computer program product of claim 16, wherein the computer usable program code for propagating the context information associated with the first software component comprises the computer usable program code for embedding the context information associated with the first software component in the invocation message.

18. The computer program product of claim 17, further comprising:
computer usable program code for running the second software component in a second session;
computer usable program code for creating a second context carrier associated with the second session; and
computer usable program code for creating a second context entry in the second context carrier, wherein the second context entry stores the context information associated with the first software component.

19. The computer program product of claim 18, further comprising:
computer usable program code for terminating the first software component; and
computer usable program code for deleting the first context carrier.

20. The computer program product of claim 18, further comprising:
computer usable program code for returning a reply message from the second software component to the first software component, wherein the reply message has embedded therein the context information associated with the first software component;
computer usable program code for invoking the first software component;
computer usable program code for creating a third context carrier associated with the first session; and
computer usable program code for creating a third context entry in the third context carrier, wherein the third context entry stores the context information associated with the first software component.
